(19) United States
(12) Patent Application Publication
(10) Pub. No.: US 2011/0226897 A1
(43) Pub. Date: Sep. 22, 2011

(54) Launch vehicle fairing and construction

(76) Inventors: Joseph F. Padavano, Lovettsville, VA (US); Warren R. McCrary, Hamilton, VA (US)

(21) Appl. No.: 10/804,262

(22) Filed: Mar. 19, 2004

(51) Int. Cl. B64G 1/66

(52) U.S. Cl. 244/1 N

(57) ABSTRACT

Light-weight acoustic dampening launch vehicle fairing structures having high strength and stiffness and capable of filling to provide high mass density and rapidly unloaded at a predetermined time following launch, and methods of making them are provided. The panels include a monolithic body comprised of fibrous reinforcement material in a polymeric binder and comprise longitudinal chambers extending from the length of body. Fluid passage means are provided at both the top and bottom of the monolithic body and interconnected by the longitudinal chambers for filling and emptying said chambers with a fluid.

### STATEMENT REGARDING FEDERALLY SPONSORED RESEARCH OR DEVELOPMENT

This application is in part the result of funding provided by the Department of the Air Force, AF Research Laboratory Contract F29601-01-C-0142. The government may have certain rights in this invention.

### BACKGROUND OF THE INVENTION

The invention relates to a new acoustic dampening launch vehicle fairing structure and methods of constructing it. The fairing is extremely light in weight, is high in strength in its light weight form, and can easily be provided with significant mass for application as a sound barrier for rocket-launched payloads. The unique structure and capabilities of the fairings of the invention enable their rapid assembly adaptation to unique payloads and missions.

Acoustic barriers are typically employed to protect rocket payloads, such as sensitive communications satellites, from the rigors of sound vibration generated by rocket engines at launch. Acoustic stress on sensitive payload equipment is typically at a maximum in the initial liftoff phase of launch. At launch, acoustic pressure waves reflect from the ground and excite skin panels on the launch vehicle. Reflected pressure waves induce vibration in the payload fairing in addition to directly exciting the payload structure. FIG. 1 illustrates this schematically, which shows a rocket launch vehicle 10 in launch configuration. The engine 12 generates sound waves, which are reflected as waves 14 and 14′ (shown in dashed lines) from the ground and nearby structures toward the launch vehicle 10. The stress, if left unchecked, can easily damage electronic, solar panel, antennae, and robotic payload components held within fairing 16 at the top of the launch vehicle. It has been common practice to provide heavy blankets to attenuate launch acoustics; however, blankets do not attenuate low frequencies and add weight that increases the need for fuel. Spacecraft must be designed for severe launch environments and efforts to reduce weight will be rewarded by reductions in cost.

In U.S. Pat. No. 5,445,861, Newton, et al., point out that typical launch vehicle engines produce sound pressure levels nearing 155 dB at the payload position. They note that launch vehicles typically include a payload shroud, designed to surround the payload and absorb acoustic energy, thereby reducing the level of acoustic energy reaching the payload. Such a shroud also protects the payload from dynamic air pressure and heating during liftoff, as well as airborne hazards while the payload is sitting on the launch pad. They note that payload shrouds have been built of aluminum and composite materials such as carbon/epoxy honeycomb, and fiber glass blankets have been placed around the inside of shrouds to further absorb acoustic energy and to provide thermal insulation. They criticized prior art payload shrouds as suffering from at least three related problems: one, they are excessively heavy; two, they are excessively costly; and three, they do not provide sufficient acoustic protection for the payload. When used, fiber glass blankets introduce a source of contamination due to fiber glass dust which collects in large quantities within the blankets.

To meet these challenges, Newton, et al., proposed a payload shroud made of a plurality of composite panels that are described as strong and lightweight and are said to provide good acoustic insulation. Each panel comprises an outer panel, an inner panel and a large-celled middle honeycomb layer disposed between the inner and outer panels. The inner and outer panels are themselves panel structures, which comprise inner and outer skins separated by a small-celled honeycomb or thermoplastic foam layer. Acoustic protection is provided by the panel structure by both passive viscous damping and the use of tuned cavity absorbers built into the middle large-celled honeycomb layer. The passive viscous damping is provided by a layer of viscous damping material disposed between the inner panel and the large-celled honeycomb middle layer. Damping is said to occur as a result of the viscous layer transmitting shearing forces from the middle honeycomb layer to the inner panel. The large-celled middle honeycomb layer provides panel stiffness. Each large cell included within the middle honeycomb layer is tuned to a particular frequency that lies within a range of frequencies produced by the launch vehicle's engines. Water can be circulated through the outer layers for cooling, but the cells of the middle layer are left unfilled and tuned for dampening expected frequencies.

In U.S. Pat. No. 5,670,758, Borchers, et al., describe an acoustic protection for fastening onto payload fairings of expendable launch vehicles. They note that the generally known measures for reducing damaging sound call for equipping the walls with sound-absorbing materials, for example insulating panels or mats made of the most varied suitable materials. They note that multi-shell structures comprising damping and reverberant materials are also used, and propose instead acoustic absorbers tuned to a defined frequency range arranged in foamed plastic mats disposed on the insides of the payload fairing. The acoustic absorbers are each composed of a cup-shaped lower part and an upper part having a horn.

In U.S. Pat. No. 5,912,442 to Nye, et al., the use of honeycomb panels is again the preferred solution to the acoustic problem with protecting spacecraft during launch. Here, the description relates to a low vibroacoustic structure that comprises a first facesheet defining a plurality of first holes, a second facesheet defining a plurality of second holes, and a honeycomb sheet for a core. The first and second facesheets are attached to opposed surfaces of the core. The core defines a plurality of passages in communication with the first and second holes to form channels through the structure. The first and second facesheets and the core are formed of lightweight materials such as lightweight metals, metal matrix composites, or polymer matrix composites. The perforated structure is said to reduce structural acoustic coupling and acoustically induced vibration. The structure can be formed as a panel and attached to support structures exposed to high-energy acoustic environments to reduce acoustically induced vibration of the structures.

In U.S. Pat. No. 6,224,020, Hopkins, et al., described a sonic shield also utilizing a multi-layered construction and a central, modified honeycomb core. The modified honeycomb is said to be two-dimensional because the core material sheets used in traditional honeycomb are rotated relative to each other in manufacture. The resulting cells are half hexagons rotated about 45 degrees in alternate layers. This is said to provide a complex path for travel of the liquid utilized with the invention and to also provide increased wall strength. The central honeycomb is filled with water to provide mass specifically for application as a cargo fairing wall for space craft. This is said to permit acoustic protection without significantly affecting the payload lifting capability of the launch vehicle. The fairing is shown to be constructed from a number of layers of materials for specific functions surrounding a modified honeycomb layer comprised of a plurality of interconnected half-hexagon chambers through which water can enter and exit along a tortuous path. This complex design is said to permit the acoustic mass water to be jettisoned at a controlled point after liftoff, reducing fuel requirements while protecting the payload during times of greatest acoustic stress. To similar effect is U.S. Pat. No. 6,394,394. It would be desirable to provide an acoustic shield capable of providing variability of mass from the use of liquids other than water and at varying levels of chamber capacity. And, it would be desirable to do so without low fluid viscosity being a prime limiting factor due to the need to exit ballast fluid through a tortuous path of chambers.

There remains a need for light-weight acoustic dampening launch vehicle fairing structures, which provide high strength and stiffness and permit variable high mass density.

### SUMMARY OF THE INVENTION

It is an object of the invention to provide light-weight, high strength, versatile acoustic dampening launch vehicle fairing structures and methods for making them.

It is an object of the invention to provide acoustic dampening launch vehicle fairing structures having a both high strength and stiffness, accompanied by low weight.

It is another object of the invention to provide acoustic dampening launch vehicle fairing structures capable of holding variable acoustic masses.

It is another object of the invention to provide acoustic dampening launch vehicle fairing structures capable of rapidly discharging acoustic mass.

It is another object of the invention to provide acoustic dampening launch vehicle fairing structures having one-piece panel construction and methods of making them.

It is another object of the invention to provide acoustic dampening launch vehicle fairing structures that enable rapid adaptation to unique payloads and missions and to provide methods of making and adapting them.

It is another object of the invention to provide acoustic dampening launch vehicle fairing structures which enable easily varying acoustic mass composition and volume and to provide methods of making them.

It is another object of the invention to provide a method for acoustic dampening launch vehicle fairing structures which enables easily varying acoustic mass chamber size.

It is yet another object of the invention to provide a method for making monolithic acoustic dampening launch vehicle fairing structures having both high strength and stiffness, accompanied by low weight.

It is yet another object of the invention to provide a method for making monolithic acoustic dampening launch vehicle fairing structures having a very high stiffness to weight ratio and the capability to easily add and remove mass to enable rapid establishment of high strength acoustic dampening launch vehicle fairing structures.

These and other objects are accomplished by the invention which provides a monolithic, high strength acoustic dampening launch vehicle fairing structures, methods for their manufacture, and composite structures including the acoustic dampening launch vehicle fairing structures.

In one aspect the invention provides a light-weight acoustic dampening launch vehicle fairing structure having high stiffness, and low weight but capable of being loaded to provide high mass density for launch and rapidly unloaded at a predetermined time following launch, comprising: a monolithic body having a top and a bottom, a inboard surface, an outboard surface on the exterior of a central core comprised of fibrous reinforcement material in a polymeric binder defining longitudinal chambers extending from the top to the bottom of the monolithic body; fluid passage means are provided for The longitudinal chambers at both the top and bottom of the monolithic body to enable filling and emptying said chambers with a fluid.

Among the preferred aspects are provision of high strength and stiffness, accompanied by low weight. And, it is also preferred that the panel in some embodiments comprise a light weight filler material partially filling the chambers.

In another aspect, the invention provides a method for making monolithic acoustic dampening launch vehicle fairing structures having a very high strength to weight ratio, comprising: providing a plurality of removable mandrels; covering the mandrels with a fibrous reinforcement material; arranging a plurality of mandrels covered with fibrous reinforcement material in a predetermined array wherein the fibrous reinforcement material covering each mandrel contacts the fibrous reinforcement material covering a next adjacent mandrel, the mandrels being arranged to define a inboard surface and a outboard surface; laying a fibrous reinforcement material over both the inboard surface and the outboard surface; impregnating all fibrous reinforcement material with sufficient polymeric binder to form an impregnated assembly; and subjecting the impregnated assembly to pressure for a time and at a temperature effective to compress and shape the impregnated assembly into a predetermined configuration; and removing the mandrels thereby opening longitudinal chambers within a monolithic body having a top and a bottom, a inboard surface, a outboard surface on the exterior of a central core with the longitudinal chambers extending from the top to the bottom of the monolithic body.

In one preferred variation of the process, individual chamber forming tubes of resin bonded fibrous reinforcement material are formed by pultrusion and utilized in the process instead of laying them up with the use of mandrels. In this variation, the process includes the following steps: providing a plurality of tubes comprised of fibrous reinforcement material; arranging a plurality of the tubes in a predetermined array wherein each tube contacts a next adjacent tube, the tubes being arranged to define a inboard surface and a outboard surface; laying a fibrous reinforcement material over the inboard surface and the outboard surface; impregnating all fibrous reinforcement material with sufficient polymeric binder to form an impregnated assembly; and subjecting the impregnated assembly to pressure for a time and at a temperature effective to compress and shape the impregnated assembly into a predetermined configuration.

The various preferred processing procedures include the use of compression molding with expendable mandrels and a multipart female mold with one or more moveable members. Also suitable is pressure molding using an expandable mandrel within a rigid female mold. The processing can also include a co-cure process where all components are assembled over an inner mold, placed in a vacuum bag, and subjected to reduced pressure to final setting of the resin binder. In a variation on this procedure, the various components can be assembled still in need of binder, placed within a vacuum bag mold apparatus and sequentially feed in resin and subject the composite to vacuum.

A number of preferred aspects of the invention will be described below.

### BRIEF DESCRIPTION OF THE DRAWINGS

The invention will be better understood and its advantages will become more apparent when the following detailed description is read in light of the accompanying drawings, wherein:

FIG. 1 is a schematic perspective view of a rocket launch vehicle holding a payload protected by an acoustic dampening launch vehicle fairing structure of the invention.

FIG. 2 is a perspective view, enlarged from that of FIG. 1, showing the fairing structure portion of the launch vehicle.

FIG. 3 is a perspective view, enlarged from that of FIG. 1, showing the fairing structure portion of the launch vehicle being jettisoned.

FIG. 4 is a perspective cross sectional view taken along line 4-4 in FIG. 2 showing the fairing structure portion of the launch vehicle.

FIG. 5 is a perspective cross sectional view of one half shell for forming the sectioned fairing illustrated in FIG. 4.

FIG. 6 is a perspective cross sectional view taken along line 6-6 in FIG. 2 of one half fairing shell.

FIG. 7 is a graph summarizing transmission loss data for a fairing structural panel made in accord with the invention, showing good effectiveness throughout the range of frequencies applied, with good results in a critical range of under 500 Hz.

FIG. 8 illustrates one overall procedure for forming the monolithic structures of the invention.

FIG. 9 is a schematic representation of one technique for forming fibrous tubes for forming the monolithic structures according to the invention.

FIG. 10 is a schematic of a process variation.

FIG. 11 is a schematic of another process variation.

### DETAILED DESCRIPTION OF THE INVENTION

The invention has particular advantage in the provision of monolithic panels effective to provide acoustic dampening for launch vehicle fairing structures, including at frequencies at 500 Hz and below and their high stiffness and low weight The fairings are extremely light in weight, high in stiffness and strength, and can easily be provided with variable additional mass that can be rapidly expelled upon exiting the point of maximal acoustic stress. The unique structure and capabilities of the monolithic acoustic panels of the invention enable their rapid assembly adaptation to unique payloads and missions. The high resistance to bending, i.e., stiffness, that they offer is an advantage that aids in acoustic dampening.

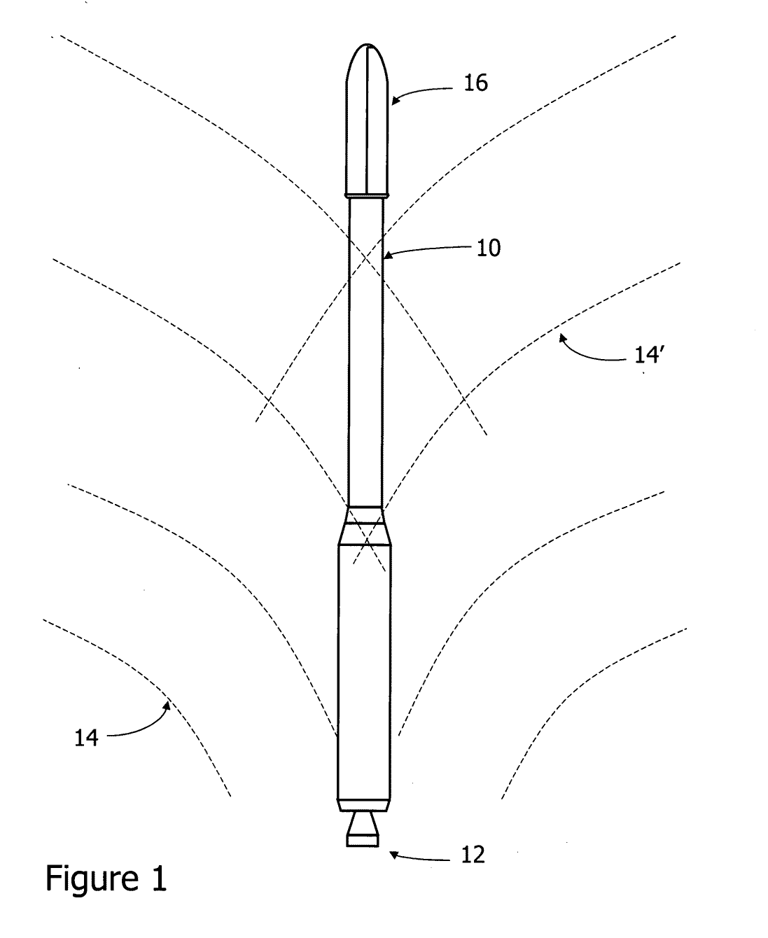

FIG. 1 shows a rocket launch vehicle 10 in launch configuration. The engine 12 generates sound waves, which are reflected as waves 14 and 14′ (shown in dashed lines) from the ground and nearby structures toward the launch vehicle 10. The stress, if left unchecked, can easily damage electronic, solar panel, antennae, and robotic payload components held within fairing 16 at the top of the launch vehicle. The fairing 16 of the invention is of constructed of a monolithic material and eliminates the use of honeycomb structures as core and strength elements. This has the unexpected advantages that acoustic protection is not diminished as compared to honeycomb structures, but significant strength to weight ratio improvements are achieved and the panels can be more quickly emptied, thus eliminating a payload weight penalty for carrying water or other shielding mass longer than is necessary.

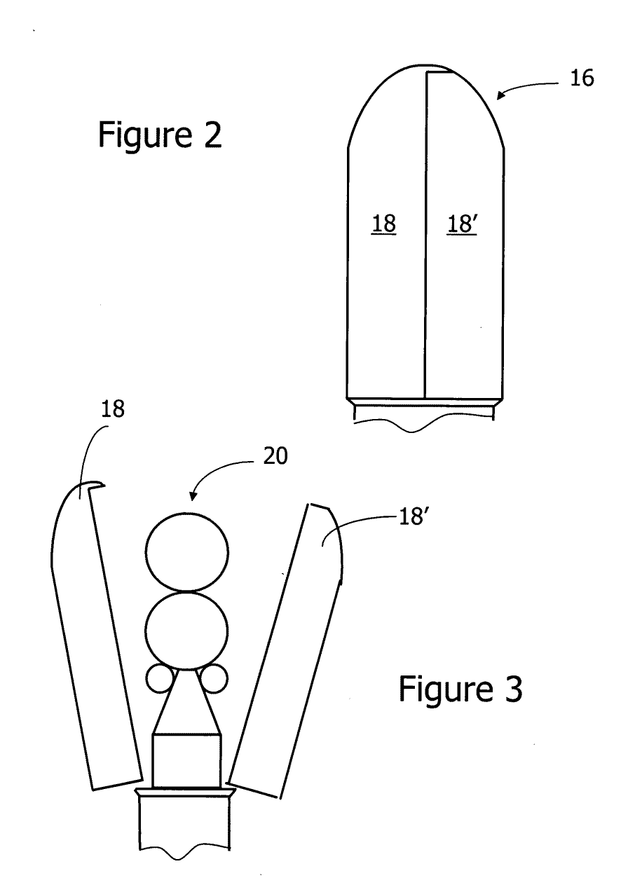

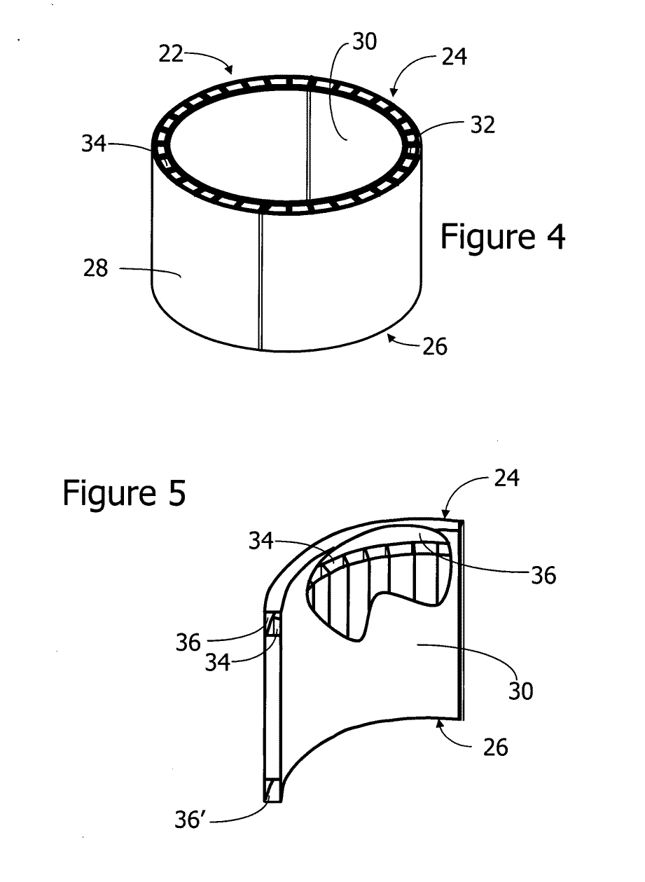

FIG. 2 is a perspective view, enlarged from that of FIG. 1, showing the fairing structure 16 portion of the launch vehicle 10, and FIG. 3 is a perspective view, enlarged from that of FIG. 1, showing the fairing structure portion 16 of the launch vehicle being jettisoned as two component panels, 18 and 18′ both of complex curvature, revealing a payload 20. FIG. 4 is a perspective cross sectional view taken along line 4-4 in FIG. 2 is a perspective view showing the interior configuration of the fairing structure 16 in a hoop direction, i.e., the direction around the circumference of the assembled fairing and perpendicular to the direction of acceleration of the vehicle 10. The stiffness of a structure of this shape will naturally have high stiffness in the hoop direction. It is an advantage of the invention that stiffness in the longitudinal direction is better than can be achieved with honeycomb materials of similar weight and dimension.

The light-weight acoustic dampening launch vehicle fairing structure has a high strength and stiffness and low mass density. The structure comprises a monolithic body 22 having a top 24 and a bottom 26, a inboard surface 28, an outboard surface 30 on the exterior of a central core 32 comprised of fibrous reinforcement material in a polymeric binder defining longitudinal chambers 34 extending from the top 24 to the bottom 26 of the monolithic body 22. Fluid passage means 36 and 36′ are provided for the longitudinal chambers 34 at both the top and bottom of the monolithic body to enable filling and emptying said chambers with a fluid. FIG. 5 shows one half of a fairing structure of FIG. 4, with a section cut away along line 5-5 in FIG. 4, to show the internal structure including one of the longitudinal chambers 34 extended in the direction parallel with acceleration of the vehicle 10. The fluid passage means 36 and 36′ are shown as integral circumferential manifolds for filling and draining of the longitudinal tubes 34, but can be holes cut following molding body 22. In either or other form, they can be formed during molding or they can comprise mechanical fittings (not shown) supplied before or after molding. External fill valves of any effective form will be provided on means 36 and external drain valves on means 36′, but are not shown in this view for clarity. The drain valves will be provided with actuator means of known type to allow the water to be released in flight, such as a pyrotechnic valve or burst disk.

The terms “inboard surface” and “outboard surface” are chosen for convenience in describing what are shown in the drawings as opposed spaced surfaces. The terms “inboard” and “outboard” in this description can be viewed as describing, in the case of a satellite payload fairing, the outer and inner surfaces, respectively. Thus, as shown, the inboard surface 28 has a compound convex curvature of the type useful for this application, and the outboard surface 30 is illustrated as being concave. Outside of this context, the terms can be reversed in terms of what is the exterior surface of a finished panel in use and what is the on the opposite side of it.

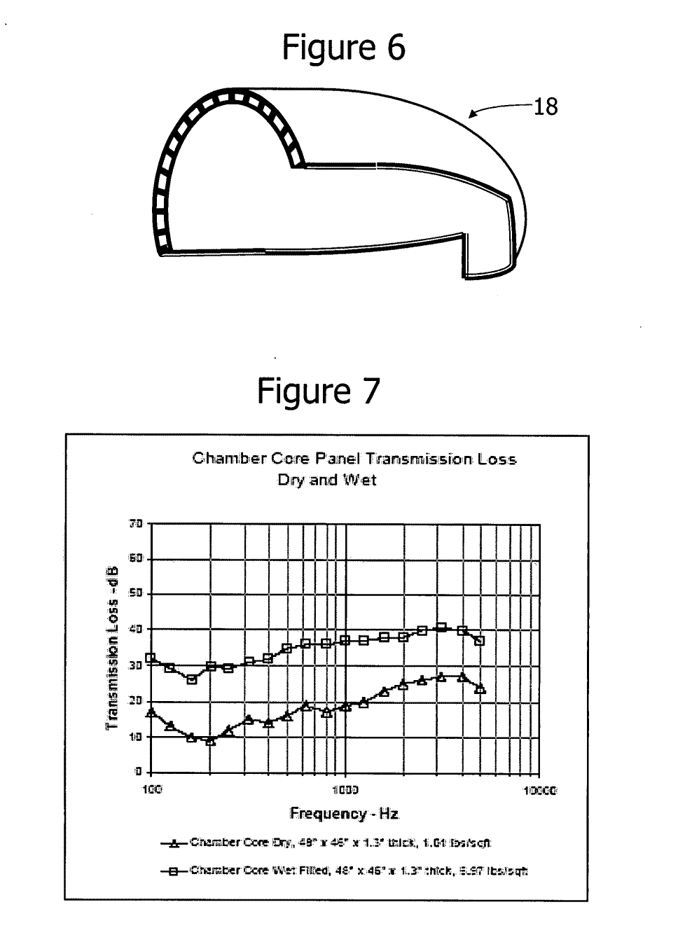

FIGS. 4, 5 and 6 schematically represent one form of panel 22 for forming the fairings 16 of the invention. In this case it is shaped for use in forming a fairing for protecting a rocket-launched payload from acoustic stress. The panel 22 of the invention is of monolithic structure and eliminates the use of honeycomb structures as core and strength elements with the unexpected findings that acoustic protection is not diminished, significant strength to weight ratio improvements are achieved and the panels can be more quickly emptied, thus eliminating a payload weight penalty for carrying water or other shielding mass longer than is necessary. In addition, the ability to form fairings without the need for honeycombs facilitates the formation of compound curvatures, such as the complex curves of FIG. 6, frequently required for aerodynamic effect. The invention enables achieving the compound curvatures without sacrificing strength or aesthetics or adding weight.

The longitudinal chambers 34 are preferably free of internal obstructions and provide an efficient path for a fluid, such as water or the like, to be filled into the chambers 34 and exhausted from them. Fluid passage means 36 at the top and similar fluid passage means 36′ at the bottom of the monolithic body 22 are interconnected by the longitudinal chambers 34 for filling and emptying said chambers 34 with a fluid. The provision of a monolithic structure with unobstructed longitudinal chambers 34 extending the length of the panel, from top to bottom, provides an improved manner to provide mass to help absorb physical stresses such as of impact or acoustic energy. As noted above, the chambers 34 can be and are preferably filled with a fluid to add mass. By the term fluid we mean a material which flows under its own weight or under moderate applied pressure. It can be a liquid or a flowable solid, such as sand, or the like. Typically, the fluid will be a liquid material and will have a viscosity suitable for the intended use, with viscosities within the range of from about 0.5 to about 20 centipoise, as measured at 25° C., being most typical. Lower viscosities are preferred to facilitate filling and draining, however the acoustic attenuation properties of the fluid must also be considered. Water, aqueous mineral slurries, non aqueous slurries, and the like can be employed. They can be Newtonian, dilatent or pseudoplastic as the situation calls for.

FIG. 5 shows fluid passage means 36 and 36′ at both the top 24 and bottom 26 of the monolithic body 22 and interconnected by the longitudinal chambers 34 for filling and emptying said chambers with a fluid. By the terms “top” and “bottom” as used in this description, we are referring to the general orientation of the structures of the invention as shown in the drawings, wherein a fluid is introduced from the top and flows by gravity out of the bottom in an earth based system without the use of any pumping or other flow inducing added forces. However, for rockets at launch the g forces on the device may effectively be at an orientation of less than vertical, with the term “top” still referring to an inlet end or edge and the term “bottom” still referring to an outlet end or edge.

Because longitudinal chambers 34 are constructed as open channels without any obstructions along their length, they have the noted advantage of being easy to fill and empty. In addition, this construction permits the channels to be easily partially filled with a material such as a foamed plastic or the like to adjust the internal volume for holding a fluid. In this manner, the acoustic protection and weight can be optimized for a specific space flight or other application, while utilizing a panel of standard construction. The chambers can be partially filled, by inserting removable chamber defining means, e.g., flexible rods or the like, into the chambers 34 in a manner that permits appropriate volume adjustment and spacing, filling in the remaining void space within chambers 34 with a suitable filler, and removing the removable means. If desired, expendable spacers can be attached along the length of the rods or other removable means. In one preferred procedure, rods are placed in the chambers, a closed-cell polyurethane foam is filled into the space not occupied by the rods and the rods are then removed after the polyurethane has sufficiently set. The result is a polyurethane or other filler layer partially filling the chambers as a manner to adjust the amount of liquid the chambers will hold. It is also a manner of tuning the chambers to be effective at particular sonic frequencies.

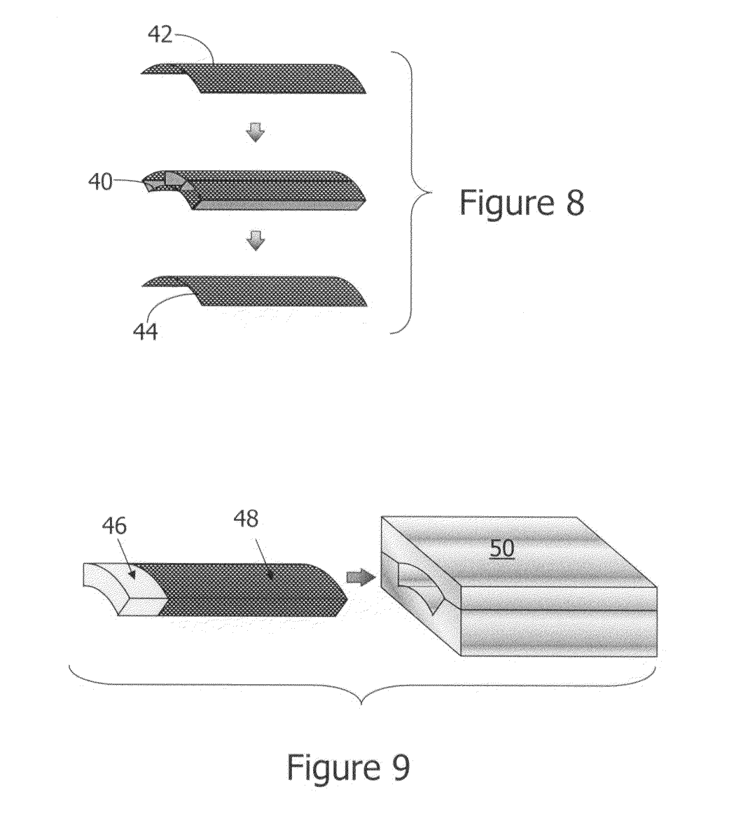

FIG. 8 illustrates the one overall procedure for forming the monolithic structures of the invention. In general terms, a plurality of tubes 40 are aligned, each with an exterior surface in contact with those of adjacent tubes 40. A inboard layer 42 of fibrous reinforcement material is placed onto the plurality of tubes 40 and an outboard layer 44 of fibrous reinforcement material is placed into contact with the opposite side of the tubes 40. The components will be impregnated with suitable and sufficient resin binder either before or after assembly. The resulting assembly of tubes 40 and inboard layer 42 and outboard layer 44 is then subjected to suitable molding conditions to set the components into a monolithic structure of high strength and having continuous channels running the length of the structure.

FIG. 9 illustrates one preferred method for making tubes 40 of the type discussed above for making the monolithic barrier panel structures of the invention. A form or mandrel 46, of desired regular cross section for forming the longitudinal chambers 34 in the monolithic body 22 is provided. As will be described, the mandrels can be made of any suitable material and can be rigid, flexible or expandable as the exigencies of the processing materials and panel shape and use may guide. The mandrels 46 can be made of a material, such as a water soluble molding compound, which permits their removal following final shaping by at least partially dissolving them with water or other suitable solvent. Among commercial materials that can be effective are AQUACORE™ wash out core material. AQUACORE™ is a high-temperature, water-soluble mandrel material that can be used in fugitive, lost core, and trapped tooling procedures. AQUACORE™ comes pre-mixed and can be packed, either by hand or hydraulic pressed into the desired geometry. Once dried, (recommended drying temperature is 200° F., or 93.3° C.) AQUACORE™ can be machined into specific shapes and sizes. With a specific gravity of 0.45 wet, it is lightweight, easily machined and thermally stable. It is available from Advance Ceramics Research, Inc. Other wash away casting compounds can also be employed, such as TI4150 Powder (this is currently the preferred material), available from TI International, Ltd. The mandrels 46 can also be of a rigid; strong material such as steel which can be removed along a straight or curved path. Rubber or other elastomeric mandrels 46 may also be employed, and they can be either of constant cross section or expandable.

The mandrels 46 are wrapped with a suitable fibrous reinforcement material 48. The fibrous reinforcement 48 can be in the form of a strand, cloth, or bat of a suitable high strength reinforcement such as graphite, glass, metal, polymer, or the like. Among specific preferred materials are stabilized graphite fiber, glass, carbon, Kevlar® aramid fiber, silicon carbide, aluminum oxide, ceramics, and steel. The reinforcing and/or fusible fibers may have a circular or noncircular cross-section as described in U.S. Pat. No. 5,910,456. Examples of useful reinforcing fibers and fibrous materials are given in U.S. Pat. No. 4,894,286, U.S. Pat. No. 5,002,750, and U.S. Pat. No. 6,638,883. Reinforcing fibers are generally characterized in that they do not substantially deform under conditions of high heat (e.g., up to 300° C.) and pressure. Preferably, the reinforcing fibers are stabilized carbon precursor fibers, such as oxidized polyacrylonitrile fibers or oxidized pitch fibers. If desired, combinations of different materials and forms can be employed for the fibrous reinforcement material at this stage in processing, later stages or within a particular stage. For example, graphite fiber is extremely strong to tensile failure, while Kevlar® fiber has an extremely high toughness. Thus, graphite fiber might be applied first and Kevlar® fabric applied there over, or vice versa. Alternatively, a woven or nonwoven fabric or sheet or oriented or unoriented fibers of Kevlar® and graphite composite can be used. A preferred material is comprised of graphite fiber fabric having an approximate thickness of 0.22 mm per layer, with the sheets being laid up with alternating layers having fibers arranged at angles of from about 45° to about 90° to each other.

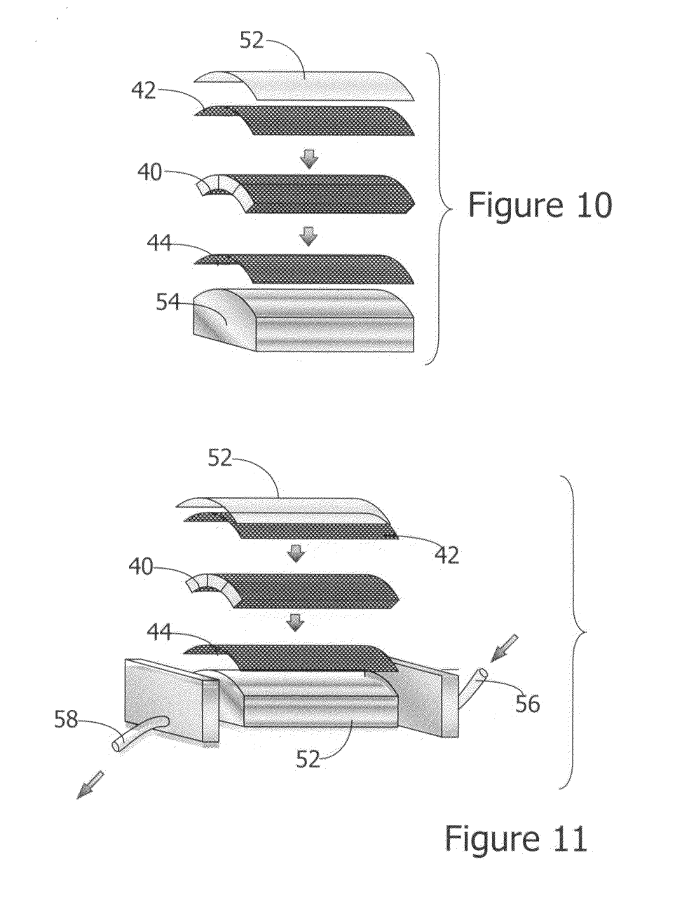

Following the step of covering the mandrels 46 with fibrous reinforcement material 48, they can be molded such as under heat and pressure in a suitable mold, such as two piece mold 50, shown in FIG. 9. Alternatively, a plurality of wrapped mandrels can be arranged in a predetermined array as shown in FIGS. 10 and 11, wherein the fibrous reinforcement 48 material covering one mandrel 46 contacts the fibrous reinforcement material covering a next adjacent mandrel, the mandrels being arranged to define a inboard surface 28 and an outboard surface 30. The arrangement of the mandrels will determine the shape of the inboard 28 and outboard 30 surfaces of the final monolithic structure 22. Once suitably arranged, a layer 48 of fibrous reinforcement material arranged over the inboard surface 28 and another layer 48′ fibrous reinforcement material is arranged over the outboard surface 30.

To achieve a strong, monolithic structure, it is important that all fibrous reinforcement material be impregnated with a polymeric binder to form an impregnated assembly comprised of, for example the components 40, 42 and 44, shown in FIG. 8. The binder can be applied wholly after assembly or can be partially or wholly applied by preimpregnating the various portions of fibrous reinforcement materials employed. Among the suitable polymeric binders are those such as the phenolics, polyesters, epoxies, and the like known for similar applications. In particular, the E-765, 3501, and TCR resin systems are preferred in many applications, especially in combination with T-300, T-700 and/or IM7 fibrous reinforcement materials. Once impregnated, the impregnated assembly (40, 42, 44) is subjected to pressure for a time and at a temperature effective to compress and shape the impregnated assembly into a desired configuration. Those skilled in the art will know these based upon the selection of particular binders and fibrous reinforcement materials, with the following examples being a guide.

Following final setting of the resin binder, the mandrels 46 are removed. This opens the longitudinal chambers 34 within a monolithic body 22 having a top and a bottom, a inboard surface, an outboard surface and a central core with the longitudinal chambers extending from the top to the bottom of the monolithic body. The panels produced are extremely strong and stiff, in preferred forms the strength to weight ratio is at least about 60,000 psi/lb.

The various preferred processing procedures include the use of compression molding with expendable mandrels and a multipart female mold with one or more moveable members, as illustrated, for example in FIG. 9. Also suitable is pressure molding using an expandable mandrel within a rigid female mold. The processing can also include a co-cure process where all components 40, 42 and 44 are assembled over an inner mold 54, placed in a vacuum bag 52, and subjected to reduced pressure to final setting of the resin binder, as illustrated, for example in FIG. 10. In a variation on this procedure, the various components can be assembled still in need of binder, placed within a vacuum bag mold apparatus and sequentially fed in resin at 56 and subjected the composite to vacuum at 58, as illustrated, for example in FIG. 11.

The following examples are provided to better explain and illustrate the invention but are not to be taken as limiting in any regard. Unless otherwise indicated, all parts and percentages are by weight and are based on the weight of the product or component at the indicated stage in processing.

### Example 1

This example describes the preparation of a panel structure of the invention, with the particular application as an acoustic barrier for use in protecting rocket launched payloads.
1. A series of sixty core mandrels are constructed of Washaway Molding Compound to a dimension of about 2.5 by 2.5 centimeters in approximately square cross section and lengths of about 2 meters.
2. Each of the cores is wrapped with IM7 or other appropriate graphite fiber using a semi-automated braiding machine. Alternatively a hand layup with woven or unidirectional graphite cloth may be used. Typical fiber angles of ±45° are used on the cores.
2A. Layers of IM7 or other appropriate graphite fiber fabric having an approximate thickness of 0.22 mm per layer are applied to a male mandrel that has the shape of the interior of the completed part. Fiber angles for these layers will typically be 0° and 90°.
3. The wrapped cores are then assembled over the layers of fabric on the mandrel with surfaces in contact. Wrapped cores will typically be arrayed around the male mandrel and parallel to the mandrel centerline.
4. Additional layers of IM7 or other appropriate graphite fiber fabric having an approximate thickness of 0.22 mm per layer are then placed over the outer surfaces of the wrapped cores. Fiber angles for these layers will typically be 0° and 90°.
5. The resulting composite is impregnated with TCR resin from Alliant Techsystems or with film resin such as that from SP Systems. Alternatively any number of appropriate prepreg resin systems can be used in the layup process. Infusing liquid resin into the layup by resin transfer molding is also an acceptable method of impregnation.
6. The impregnated composite is then molded into a monolithic structure by applying external heat and pressure. Cure of the composite is typically performed in an autoclave but vacuum bag and oven cure can also be used. Alternatively, a room temperature cure resin may be used.
7. The cores are removed by washing them out with pressurized steam and/or hot water.
8. Circumferential channels for filling and draining the panel are added to the longitudinal channels formed by removal of the cores. These circumferential channels can be formed concurrently with the longitudinal channels using the same process of wrapping ring-shaped core mandrels and incorporating them into the layup. Alternatively the circumferential channels can be formed separately from either composite or metallic materials and can be attached to the primary panel in a secondary bonding operation. Openings between the circumferential and longitudinal channels allow the unobstructed passage of water or other acoustic damping material.
9. The circumferential channels are fitted with valves to permit water to be filled into and removed from the panel.
FIG. 7 is a graph summarizing transmission loss data for a fairing structural panel made in accord with the invention, showing good effectiveness throughout the range of frequencies applied, with good results in a critical range of under 500 Hz.

The above description is intended to enable the person skilled in the art to practice the invention. It is not intended to detail all of the possible modifications and variations that will become apparent to the skilled worker upon reading the description. It is in-tended, however, that all such modifications and variations be included within the scope of the invention that is seen in the above description and otherwise defined by the following claims. The claims are meant to cover the indicated elements and steps in any arrangement or sequence that is effective to meet the objectives intended for the invention, unless the context specifically indicates the contrary.

1. A light-weight acoustic dampening launch vehicle fairing structure having high stiffness, and low weight but capable of being loaded to provide high mass density for launch and rapidly unloaded at a predetermined time following launch, comprising:
a monolithic body having a top and a bottom, a inboard surface, an outboard surface and a central core comprised of fibrous reinforcement material in a polymeric binder defining longitudinal chambers extending from the top to the bottom of the monolithic body;
fluid passage means at both the top and bottom of the monolithic body and interconnected by the longitudinal chambers for filling and emptying said chambers with a fluid.

2. A fairing structure according to claim 1, wherein the strength to weight ratio is at least about 60,000 psi/lb.

3. A fairing structure according to claim 1, further comprising means to enable the volume of the longitudinal chambers to be quickly decreased to allow tailoring of the volume of the attenuation fluid.

4. A fairing structure according to claim 1, further comprising a light weight filler material partially filling the chambers.

5. (canceled)

6. (canceled)

7. A light-weight acoustic dampening launch vehicle fairing structure having high stiffness, and low weight but capable of being loaded to provide high mass density for launch and rapidly unloaded at a predetermined time following launch, comprising:
a monolithic body having a top and a bottom, a inboard surface, an outboard surface and a central core comprised of fibrous reinforcement material in a polymeric binder defining longitudinal chambers extending from the top to the bottom of the monolithic body;
fluid passage means at both the top and bottom of the monolithic body and interconnected by the longitudinal chambers for filling and emptying said chambers with a fluid, wherein the strength to weight ratio for the structure is at least about 60,000 psi/lb.

8. A light-weight acoustic dampening launch vehicle fairing structure having high stiffness, and low weight but capable of being loaded to provide high mass density for launch and rapidly unloaded at a predetermined time following launch, comprising:
a monolithic body having a top and a bottom, a inboard surface, an outboard surface and a central core comprised of fibrous reinforcement material in a polymeric binder defining longitudinal chambers extending from the top to the bottom of the monolithic body;
fluid passage means at both the top and bottom of the monolithic body and interconnected by the longitudinal chambers for filling and emptying said chambers with a fluid; and
means to enable the volume of the longitudinal chambers to be quickly decreased to allow tailoring of the volume of the attenuation fluid.
